(19) United States
(12) Patent Application Publication
(10) Pub. No.: US 2020/0186487 A1
(43) Pub. Date: Jun. 11, 2020

(54) RECOMMENDING COMMUNICATION PATHS TO CONNECT WITH NEW CONTACTS BASED ON DIGITAL ALLIANCE DATA

(71) Applicant: Project Affinity, Inc., San Francisco, CA (US)

(72) Inventors: Hansen QIAN, San Francisco, CA (US); Rohan SAHAI, San Francisco, CA (US); Ray ZHOU, San Francisco, CA (US); Shubham GOEL, San Francisco, CA (US)

(21) Appl. No.: 16/215,534

(22) Filed: Dec. 10, 2018

(51) Int. Cl. H04L 12/58; G06F 16/9535; G06F 16/9536; H04L 29/08; G06Q 10/10

(52) U.S. Cl. CPC H04L 51/32; G06F 16/9535; G06Q 50/01; H04L 67/306; G06Q 10/107; G06F 16/9536

(57) ABSTRACT

A computer-implemented method is disclosed. The method comprises managing a plurality of user accounts, including a first user account associated with a first user and a first user device and a second user account associated with a second user and a second user device, the first user account being associated with an alliance network comprising the second user account as an alliance network member to the first user account. The method further comprises determining one or more interests of the first user from a first set of data sources, including a user profile associated with the first user account, an online activity log associated with the first user account, and a first plurality of digital communications offered by the first user account for exploration of relationships. The method further comprises detecting a new contact of the alliance network and identifying one or more interests of the new contact from a second set of data sources. In addition, the method comprises identifying, in response to determining that the one interest of the new contact matches the one interest of the first user, a communication path from the first user to the second user; and transmitting, in response to determining that a communication score of the communication path exceeds a certain threshold, certain data related to the communication path to the first user device.

### FIELD OF THE DISCLOSURE

One technical field of the present disclosure is digital communication processing. Another technical field is computer-implemented analysis of digital communications including automatic filtering and transmission of messages and electronic documents.

### BACKGROUND

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

The Internet has made it easy to connect with others electronically but also challenging to manage such connections. Existing social network systems and professional network systems typically create and store digital records of friends or connections based upon a binary sense of linkage: a first user account is either a friend or connection of a second user account, or not. There are limited ways to account for the type of relationship and limited ways to filter the display of messages, electronic documents or other content based upon the type or strength of relationship. Furthermore, computer-implemented tools for supporting decisions based on type or strength of relationship are either too complex, being directed to intelligence analysis and the like, or inappropriate for business communication management. It would be helpful to have computer support to identify whom to contact for specific purposes and how to establish such a contact more efficiently and effectively.

### BRIEF DESCRIPTION OF THE DRAWINGS

In the drawings:

FIG. 1 illustrates an example networked computer system in which various embodiments may be practiced.

FIG. 2 illustrates example components of a communication management server computer in accordance with the disclosed embodiments.

FIG. 3 illustrates an example screen of a graphical user interface that shows information regarding a list of relationships visible to a first user between each of a list of allies of the first user's account and a contact.

FIG. 4 illustrates an example screen that allows querying for information regarding relationships associated within an organization.

FIG. 5 illustrates an example screen that shows search results in response to a query from a first user device associated with a first user for information regarding relationships associated with an organization.

FIG. 6 illustrates an example screen that allows querying for information regarding relationships according to a specific criterion.

FIG. 7 illustrates an example screen that shows search results in response to a query for information regarding relationships according to a specific criterion.

FIG. 8 illustrates an example process performed by the communication management server computer of managing alliances and associated relationship data.

FIG. 9 illustrates an example screen of a graphical user interface that is programmed for communicating data related to communication paths to connect a user with a contact to a user device of the user.

FIG. 10 illustrates an example screen of a graphical user interface that is programmed for communicating data related to a request for introducing a user to a contact to a user device of a member of an alliance network of the user's user account.

FIG. 11 illustrates an example process that the communication management server computer can execute for recommending communication paths to connect with a new contact.

FIG. 12 is a block diagram that illustrates a computer system upon which an embodiment of the invention may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

Embodiments are described in sections below according to the following outline:

1. GENERAL OVERVIEW

2. EXAMPLE COMPUTING ENVIRONMENT

3. EXAMPLE COMPUTER COMPONENTS

4. FUNCTIONAL DESCRIPTION
4.1. DEVELOPING ALLIANCES
4.2. UTILIZING ALLIANCES
4.3. RECOMMENDING COMMUNICATION PATHS TO CONNECT WITH NEW CONTACTS BASED ON DIGITAL ALLIANCE DATA
4.3.1. COLLECTING INTEREST DATA FOR USERS
4.3.2. COLLECTING INTEREST DATA FOR CONTACTS OF ALLIANCE NETWORKS
4.3.3. ANALYZING INTEREST DATA AND COMMUNICATION PATHS
4.3.4. COMMUNICATING SUGGESTIONS OF NEW COMMUNICATIONS

5. EXAMPLE PROCESSES

6. HARDWARE IMPLEMENTATION

1. General Overview

A communication management server computer (“server”) and related methods are disclosed to create and store digital records representing alliances between user accounts and to use the alliance records in filtering messages or other content and/or determining attributes of messages or content for display. The server allows two electronic devices associated with two user accounts to establish an alliance, where each of the two user accounts offers a set of digital communications for exploration of relationships and agrees to share certain types of information regarding the relationships with the other user account. Each user account can be associated with one or more electronic devices. The user account and each associated electronic device may be referenced interchangeably hereinafter. Two user accounts in an alliance are allies of each other and share relationship information with each other through the alliance. A second account sharing relationship information with the first account through one or more alliances is denoted and processed as a member of the alliance network of the first account. An individual that is not a user but is involved in a digital communication offered by a user account for use in the alliance network is denoted and processed as a contact of the alliance network.

For example, user accounts associated with individuals A and B are established in digital records in the system; A works for a marketing company and B works for a customer services company. A knows B and communicates with B through email. Now A hopes to expand A's network via B's connections. A is represented by A's electronic device or user account, and B is represented by B's electronic device or user account. In some embodiments, A's electronic device can be programmed to transmit a request to the server to invite B's electronic device to form an alliance. The request indicates what A offers in forming the alliance, specifically a set of digital communications between A and other individuals. For example, A might offer the messages within the email account A uses to communicate with B, where the parties (“contacts”) involved in those messages, such as senders or receivers of those messages, include C and D. The request can also indicate what A is willing to share with B. For example, A might decide to share with B only the name, an email address, and a relationship strength associated with each of A's contacts revealed by A's email messages. In addition, the request can indicate what A requests B to offer in forming the alliance, such as the messages within the email account B uses to communicate with A. The request can also indicate what A would like B to share with A, such as the name, an email address, and a relationship strength that is associated with each of B's contacts revealed by B's email messages. The server is programmed or configured to transmit, in response, an invitation based on the request to form an alliance to B's electronic device. B can accept or reject the invitation. To accept the invitation, B's electronic device can be programmed to transmit a response to the server. The server is programmed to create and store digital records representing an alliance between A's device and B's device and by association between A and B, who become allies of each other. Allies can be in symmetric positions exploring each other's relationships in similar manners regardless which ally was the inviter or which ally was the invitee. Thus, at least after an alliance is formed, any operation performed by an inviter device can be performed by an invitee device, and vice versa.

In other embodiments, A's request may not indicate what A expects from B, and B's response can indicate what B would offer or be willing to share with A upon forming an alliance. A's electronic device and B's electronic device can continue to negotiate through the server until an agreement is made.

In some embodiments, upon forming an alliance, the server is programmed or configured to determine A's relationships with A's contacts from the set of digital communications offered by A and determine B's relationships with B's contacts from the set of digital communications offered by B. The determination may be based upon metadata representing past computer-based interactions or digital communications between the user accounts. For example, the analysis of B's email messages might reveal E to be one of B's main contacts. The server can be programmed to further determine, based on B's email messages or external data sources, that E works as a manager for a technology company. Subsequently, A might need to find prospects who are managers at technology companies. A's electronic device can submit a query for information regarding such prospects to the server. According to the alliance, the server is then programmed to return the types of information regarding E that is sharable with A, such as the name, an email address, and a relationship strength associated with E, in response to the query. In addition, the server can be configured to facilitate an introduction of A by B to E, thereby expanding A's network via B's connections.

In some embodiments, the server is programmed or configured to set up an interest hierarchy having a plurality of nodes each representing an interest. For example, a first node can represent sports, and a second node under the first node can represent baseball.

In some embodiments, the server is programmed or configured to determine A's interests with respect to the interest hierarchy. As A is a user, the determination can be made from at least A's user profile, A's search history, data derived from A's user profile, A's digital communications, and additional data associated with A's account.

In some embodiments, the server is programmed or configured to detect a new contact of an alliance network of A's account, namely a new contact that has entered into A's alliance network. For each digital communication offered by a member of that alliance network for exploration of relationships, the server can be configured to identify an individual as the sender or the receiver of the digital communication and determine whether the individual is a new contact of that alliance network. For example, A's account and B's account are allies, B's account and C's account are allies, and C communicates online with D and offers that digital communication for use by A's account to the server; D can then be a new contact of the alliance network of A's account. Upon detecting the new contact D, the server can be further configured to determine D's interests with respect to the interest hierarchy mainly from the digital communications offered for exploration of relationships that involve D.

In some embodiments, the server is programmed or configured to determine whether A and D have matching interests. Upon identifying matching interests, the server is configured to identify a communication path for A to connect with D. The communication path could comprise a series of user accounts in the alliance network starting with A's account and ending with an alliance network member that has offered digital communications for exploration of relationships that involve D, where each pair of successive user accounts are in an alliance. In the given example, C's accounts can be the alliance network member, and the user accounts of A, B, and C, and digital data representing D would form a communication path. The server is further configured to compute a communication score for the communication path, which might depend on the number of user accounts involved in (or the length of) the communication path, the strength of each alliance between successive user accounts in the communication path, or the strength of the relationship between C and D.

In some embodiments, upon determining that the communication score of the communication path exceeds a certain threshold, the server is programmed or configured to transmit relevant data to A's device or C's device. The relevant data transmitted to A's device can include data related to C and D to allow A to send a request to C for introduction to D. The relevant data transmitted to C's device can include data related to A and D to allow C to introduce A to D.

In some embodiments, the server is programmed or configured to identify new communication paths that connect A to D. For example, when A's account and C's account become allies, these accounts and the digital data representing D would form a new, shorter communication path. Similarly, when B's account and E's account are allies and E's account starts offering digital communications for exploration of relationships that involve D, the accounts of A, B, and E and the digital data representing D form a new communication path. The server is also programmed to compute or recompute the communication scores for all the communication paths to see whether any of these communication scores now exceeds the certain threshold.

The communication management server computer offers many technical benefits. By using alliance data records as a basis of filtering messages that are transmitted between user accounts, for example, the server reduces the number of digital transmissions among electronic devices and thus reduces network traffic at multiple levels. Initially, fewer alliances are formed than simple links or connections, as formation of an alliance requires offering certain digital communications for relationship exploration, discovery, and development, when those digital messages are otherwise maintained in private communication accounts. Therefore, the volume of invitations and responses associated with alliances is smaller than those associated with simple links or connections. Furthermore, fewer substantive communications are made to reach the contacts of allies because the digital communications offered by the allies enable careful evaluation of significance scores of matching interests and relationship strengths and direction of communication efforts to new relationships that are more likely to be created and remain relevant. The server's ability to focus on such new relationships also increases the quality of digital communications and saves users' time. By tapping into available resources, namely automatically analyzing users' past digital communications, the server allows a user to quickly expand the user's network and accomplish project goals while bolstering existing relationships without much extra work.

2. Example Computing Environment

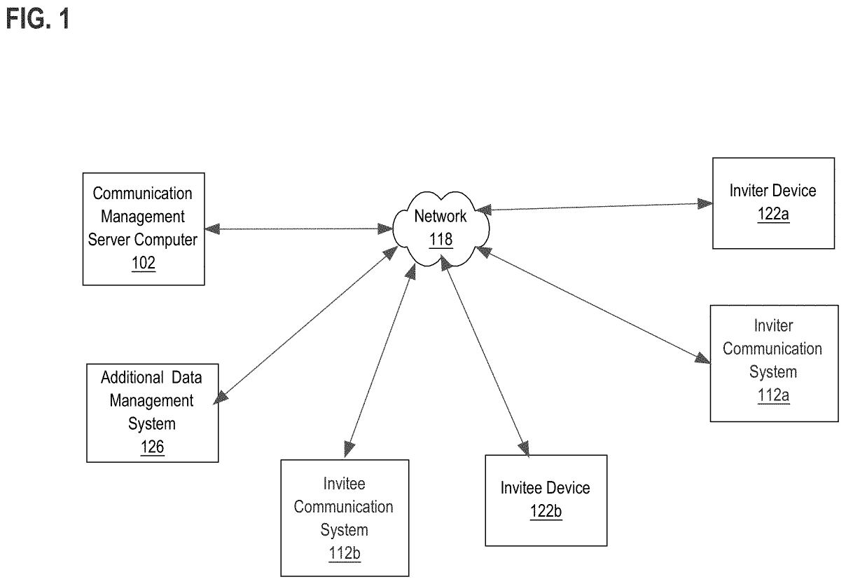

FIG. 1 illustrates an example networked computer system in which various embodiments may be practiced. FIG. 1 is shown in simplified, schematic format for purposes of illustrating a clear example and other embodiments may include more, fewer, or different elements.

In some embodiments, the networked computer system comprises a communication management server computer 102 (“server”), one or more inviter devices 122a, one or more inviter communication systems 112a, one or more invitee devices 122b, one or more invitee communication systems 112b, and one or more additional data management systems 126, which are communicatively coupled directly or indirectly via one or more networks 118.

In some embodiments, the server 102 broadly represents one or more computers, virtual computing instances, and/or instances of a server-based application that is programmed or configured with data structures and/or database records that are arranged to host or execute functions including but not limited to managing alliances each formed by two electronic devices respectively associated with two user accounts and digital communications of the two user accounts associated with the alliance. “Alliance” in this context refers to digital data stored in records in a database or other data repository that indicate or represent a relationship between a first user account and a second user account, where the existence of such a relationship drives execution of data filtering and transmission operations according to constraints, as further described herein. The server 102 can comprise a server farm, a cloud computing platform, a parallel computer, or any other computing facility with sufficient computing power in data processing, data storage, and network communication for the above-described functions.

In some embodiments, an inviter device 122a associated with an inviter is programmed to extend an invitation to an invitee device 122b associated with an invitee to form an alliance and, after an alliance is formed, explore relationships of the invitee based on certain digital communications of the invitee originally managed by the invitee communication system 112b. The inviter device 122a may comprise a desktop computer, laptop computer, tablet computer, smartphone, wearable device, or any other type of computing device with sufficient computing power in data processing, data storage, and network communication.

In some embodiments, the inviter communication system 112a is programmed to manage one or more communication accounts of the inviter holding digital communications of the inviter, such as email messages, calendar entries, phone call histories, or chat messages. Typically, such a communication account is associated with certain credentials that are required for access to the communication account and the digital communications therein. In certain embodiments, the inviter communication system 112a may be integrated with the inviter device 122a.

In some embodiments, an invitee device 122b is programmed to receive the invitation from the inviter device 112a, accept or reject the invitation, and, after the alliance is formed, explore relationships of the inviter based on certain digital communications of the inviter originally managed by the inviter communication system 112a. The invitee device 122b is otherwise similar to the inviter device 122a.

In some embodiments, the invitee communication system 112b is programmed to manage one or more communication accounts of the invitee holding digital communications of the invitee, such as email messages, calendar entries, phone call histories, or chat messages. Typically, such a communication account is associated with certain credentials that are required for access of the account and the digital communications therein. In certain embodiments, the invitee communication system 112b may be integrated with the invitee device 122b.

In some embodiments, the data management system 126 is programmed to manage one or more data sources, such as data regarding people, corporations, or other types of entities.

The networks 118 may be implemented by any medium or mechanism that provides for the exchange of data between the various elements of FIG. 1. Examples of network 118 include, without limitation, one or more of a cellular network, communicatively coupled with a data connection to the computing devices over a cellular antenna, a near-field communication (NFC) network, a Local Area Network (LAN), a Wide Area Network (WAN), the Internet, a terrestrial or satellite link, etc.

In some embodiments, the inviter device 122a is configured to send a request to the server 102 for inviting the invitee device 122b to form an alliance. The request contains information necessary to access a communication account of the inviter managed by the inviter communication system 112a, the portion of the digital communications from which relationships of the inviter can be identified for the invitee, and the types of information regarding these relationships that can be shared with the invitee. The server 102 is programmed to send an invitation based on the request to the invitee device 122b. The invitee device 122b is configured to reject or accept the invitation. To accept the invitation, the invitee device 122b is configured to send a response to the server 102. The response similarly contains information necessary to access a communication account of the invitee managed by the invitee communication system 112b, the portion of the digital communications from which relationships of the invitee can be identified for the inviter, and the types of information regarding these relationships that can be shared with the inviter.

In some embodiments, the server 102 is programmed to establish an alliance between the inviter device 122a and the invitee device 122b based on the request from the inviter device 122a and the response from the invitee device 122b. The server 102 is programmed to further access the communication accounts of the inviter and the invitee to retrieve digital communications of the inviter and invitee and identify relationships from the portions of the digital communications of the inviter and the invitee according to the alliance. In addition, the server 102 is programmed to access the data sources managed by the data management system 126 to retrieve data regarding different types of entities that may be involved in the relationships.

In some embodiments, the inviter device 122a (or the invitee device 122b) is configured to send a query for information related to certain prospects. The server 102 is programmed to respond to the query by searching the data regarding the relationships identified from the portion of the communications of the invitee (or the inviter) according to the alliance and additional data regarding the entities involved in the relationships and return the search result to the inviter device 122a (or the invitee device 122b). The search can be extended to data regarding the relationships identified from appropriate portions of the communications of the user accounts in the alliance network of the invitee (or the inviter) account, as further discussed below.

3. Example Computer Components

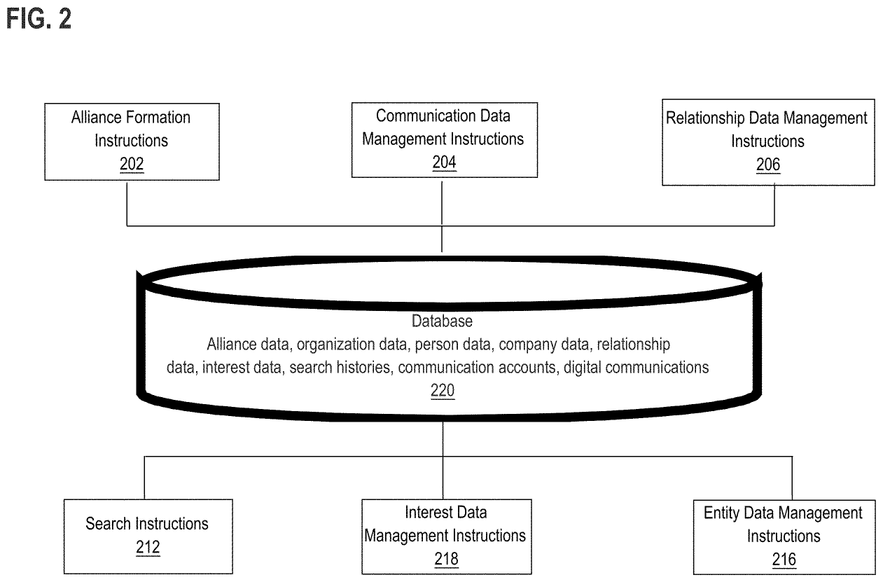

FIG. 2 illustrates example components of the communication management server computer in accordance with the disclosed embodiments. This figure is for illustration purposes only and the server 102 can comprise fewer or more functional or storage components. Each of the functional components can be implemented as software components, general or specific-purpose hardware components, firmware components, or any combination thereof. A storage component can be implemented using any of relational databases, object databases, flat file systems, or JSON stores. A storage component can be connected to the functional components locally or through the networks using programmatic calls, remote procedure call (RPC) facilities or a messaging bus. A component may or may not be self-contained. Depending upon implementation-specific or other considerations, the components may be centralized or distributed functionally or physically.

In some embodiments, the server 102 can comprise alliance formation instructions 202, communication data management instructions 204, relationship data management instructions 206, search instructions 212, entity data management instructions 216, and interest data management instructions 218. In addition, the server 102 can comprise a database module 220.

In some embodiments, the alliance formation instructions 202 enable managing the formation of an alliance between an inviter device 122a and an invitee device 122b, such as communicating with such devices in forming the alliance.

In some embodiments, the communication data management instructions 204 enable managing digital communications of the inviter and the invitee. Such management may include communicating with the inviter communication system 112a and the invitee communication system 112b to retrieve digital communications of the inviter and the invitee and managing copies or views of these digital communications in local databases.

In some embodiments, the relationship data management instructions 206 enable managing relationship data derived from the digital communications of the inviter and invitee or more broadly the digital communications offered by each user account for exploration of relationships. Such management may include identifying relationships from the digital communications and controlling which types of information regarding the relationships are made accessible to a specific user device.

In some embodiments, the search instructions 212 enable managing the search process in response to a query from a user device or in response to matching interests between a user and a new contact. Such management may include communicating with the user device and searching the relationship data in local databases for matches to the query. Such management may further include identifying a communication path that connects the user to the new contact through an alliance network member of the user's account and communicating with a device of the user or a device of the alliance network member.

In some embodiments, the entity data management instructions 216 enable managing data regarding different types of entities, such as a person or an individual, a company or a corporate entity, or an organization of any purpose, or other data relevant for relationship exploration and formation. Such management may include communicating with the data management system 126 and supplementing the relationship data with entity data or other data retrieved from external data sources.

In some embodiments, the interest data management instructions 218 enable managing interest data associated with a user or a contact. Such management may include building and maintaining an interest hierarchy with nodes representing interests. Such management may further include analyzing data associated with user accounts to determine and assess interests of a user and interests of a contact with respect to the interest hierarchy. The data associated with user accounts may include user profiles, search histories, or digital communications offered by user accounts for exploration of relationships.

In some embodiments, the database 220 is programmed or configured to manage relevant data structures and store relevant data for functions performed by the server 102. The data may correspond to alliances, organizations, persons or individuals, companies or other corporate entities, relationships, interests, search histories, communication accounts, or digital communications. As further discussed below, the server 102 can be programmed to assign each user to an organization and automatically form alliances between every pair of user accounts who belong to the same organization. For example, an organization can correspond to a corporate entity, a department within a corporate entity, a high school class, a choir, or a wine club. For further example, for an individual, values of various attributes may be stored, such as name, communication mechanisms, credentials for communication accounts, names of organizations to which the individual belongs, or names of employers. For a corporate entity, values of various attributes may also be stored, such as name, location, size, or industry.

4. Functional Description

4.1. Developing Alliances

In some embodiments, the server 102 is programmed or configured with data structures and/or database records that are arranged to receive a request for forming an alliance from an inviter device 122a associated with an inviter. The inviter could be an administrator of the server 102 or a regular user. The request identifies the inviter or the inviter device. The request also identifies an invitee, which can include a name or the ID of a communication account, such as an email address, a phone number, or a chat program user ID.

In some embodiments, the request can include information regarding access to one or more of the inviter's communication accounts, such as an account for email, event scheduling, or chat. The request can indicate a selection criterion to be applied to the digital communications in the one or more communication accounts, indicating a set of the inviter's digital communications to be associated with the alliance. The selection criterion can refer to any field of a digital communication. For example, the selection criterion can be all the email messages in the folder named “Construction Project”, all the email messages of which a specific user did not receive a copy, or all the calendar entries for events that took place during March. The request can also provide a specification of the types of information regarding relationships identified from the set of the inviter's digital communications that are to be shared with the invitee device 122b. Default types of information can include names of individuals or contacts in the relationships and the corresponding relationship strengths. Additional types of information can include, for each of those contacts, a summary of digital communications with the contact in terms of communication mechanism, frequency, nature, etc. The credentials for the one or more communication accounts, the selection criterion, or the specification of the types of information regarding the relationships to be shared can also be transmitted to the server 102 after a response is received from the invitee device 122b.

Moreover, the request can provide information regarding expanding the alliance. For example, default relationship sharing can be that only two parties that form an alliance can explore the other's relationships based on the digital communications offered by the other for relationship exploration and discovery. The default can then be expanded via a transitive relationship. For further example, A and B forms an alliance, so that information regarding A's relationships based on A's email is shared with B and information regarding B's relationships based on B's calendar entries is shared with A. Subsequently, A and C forms a separate alliance, where information regarding A's relationships based on A's chats is shared with C and information regarding C's relationships based on C's email is shared with A. The default can be that nothing is shared between B and C before they form their own alliance. The default can then be expanded by one degree of alliance, so that through A, information regarding B's relationships based on B's calendar entries is shared with C and information regarding C's relationships based on C's email is shared with B. B or A can also specify that while information regarding B's relationships based on all of B's calendar entries is shared with A, only information regarding B's relationships based on some of B's calendar entries is shared with an individual who is not B's ally. The individuals that share relationship information through one or more alliances or their user accounts are then in an alliance network. In the example above, B could be the inviter, and A could be the invitee. When a maximum degree for B's alliance network is two (one or more than default), C is allowed to share B's relationship information through A. Thus, request from the inviter device 122a can also indicate a maximum degree (with one being the default) for the inviter's alliance network or a selection criterion for each additional degree. This request can also be transmitted to the invitee device 122b after a response is received from the invitee device 122b.

Furthermore, the request can include additional privacy settings or constraints applicable to the alliance to be formed. Similar privacy settings or constraints can also be specified at the user account level applicable to all alliances formed by the inviter or associated user account. Such privacy constraints can limit the use of the alliance to be formed to varying degrees. For example, a privacy constraint can allow exploration of relationships within the inviter's communication accounts associated with this alliance only by the invitee account and other user accounts associated with specific industries or certain business positions. For further example, another privacy constraint can hide the identity of the inviter when one of the relationships that can be derived from the inviter's communication accounts is included in a search result for a search query made by a user account in the alliance network of the inviter account other than the invitee account. Another privacy constraint can specify which relationships with contacts are explorable by user accounts in the alliance network in terms of various attributes of a contact, such as an ID, name, or domain of the contact's email address.

In some embodiments, upon receiving the request, the server 102 is programmed to look up the inviter in the database 220, including identifying an organization to which the inviter belongs, as further discussed below. The server 102 can be programmed to also look up the invitee in the database 220 and when data regarding the invitee is found, identify an organization to which the invitee belongs. Then, the server 102 is programmed to prepare an invitation based on the request and have the invitation transmitted to an invitee device 122b. The invitation includes information regarding the inviter, such as the name, the organization identified for the inviter, or an email address. The invitation also indicates an intention to form an alliance with the invitee by offering each other's digital communications for relationship exploration and discovery. In addition, the invitation can include a summary of the digital communications offered by the inviter for relationships exploration and discovery. For example, the summary can be a description of the selection criterion provided by the inviter device 122a. The invitation can also include one or more other types of information included in the request.

Furthermore, the invitation includes a request to provide access to one or more of the invitee's communication accounts. The invitation can further include a request to provide a selection criterion to be applied to the digital communications in the one or more communication accounts, indicating the set of the invitee's digital communications to be associated with the alliance. In addition, the invitation can include a request to provide a specification of the types of information regarding relationships identified from the set of the invitee's digital communications that are to be shared with the inviter device 122a. The invitation can also include a request for the invitee to join the organization identified for the inviter. Furthermore, the invitation can include a request to indicate a maximum degree for the invitee's alliance network or a selection criterion for each additional degree. One or more of the requests discussed in this paragraph can also be transmitted to the invitee device 122b after a response is received from the invitee device 122b.

In some embodiments, the server 102 is programmed to receive a response to the invitation from the invitee device 122b. The response can include a rejection of the invitation, in which case the server 102 is configured to send a notification of the rejection to the inviter device 122a. Alternatively, the response can include an acceptance of the invitation. In that case, the server 102 is configured to send a notification of the acceptance to the inviter device 122a. The response can also include information that allows the server 102 to access one or more of the invitee's communication accounts. The response can also include a selection criterion to be applied to the digital communications in the one or more communication accounts. In addition, the response can include a specification of types of information regarding relationships identified from the set of the invitee's digital communications that are to be shared with the inviter device 122a. In addition, the response can include an indication of whether to join the organization identified for the inviter, to remain in the organization identified for the invitee, or to form a new organization corresponding to the alliance. Moreover, the response can include a maximum degree for the invitee's alliance network or a selection criterion for each addition degree. Similar to a request, the response can include other types of information, such as privacy settings or constraints specific to the alliance being formed. It is to be understood that the formation of an alliance can be an iterative process, with parts of the requests or response provided to the server 102 in an incremental manner in a negotiation between the inviter device 122a and the invitee device 122b until an agreement is reached. In addition, default values can be used so that not all parts of the request and response discussed above need to be communicated to the server 102.

In some embodiments, upon receiving the response, when the invitee is a new user, the server 102 is programmed to request additional information regarding the invitee and the invitee device 122b, such as a business entity the invitee works for, different contact mechanisms to reach the invitee, and so on. Overall, the server 102 is configured to store all the data received from the inviter device 122a and the invitee device 122b to the database 220, which constitute at least part of digital alliance data representing the alliance between the inviter and the invitee. The server 102 can also be programmed to transmit certain data in the response that did not correspond to any part of the request to the inviter device 122a.

In some embodiments, the server 102 is programmed to receive a request for forming an alliance from an inviter device 122a or any other user device that does not identify an invitee. The server 102 can be programmed to post an invitation corresponding to the request at an address accessible to one or more user devices, such that a selection of the address or a view of the posting by an invitee device 122b or any other user device generates an acceptance of the invitation or at least triggers a process to respond to the invitation, as described above. The server 102 can be programed to also broadcast the address to select user devices, or without any posting, directly broadcast the invitation to select user devices. Alternatively, the server 102 can be configured to rely on the sender of the request to communicate the address to other user devices. For example, the address can be in the form of a URL, and the address can be announced by the inviter device 122a to every email address in an address book associated with the inviter device 122a.

In some embodiments, the server 102 is programmed to receive a request to become a user from a user device, which is then able to extend invites to another user device to form an alliance. The request can also be submitted on behalf of another user device associated with another user. For example, a request can be to sign up all the user devices associated with all the employees of an employer, offering all the employees' email accounts for forming alliances. In response, the server 102 can be configured to assign all those user devices and the associated user accounts to the same organization, which may correspond to the employer's corporate entity. The server 102 can be programmed to further form an alliance between every pair of those user devices, so that each employee has access to the relationships revealed by every other employee's email.

In some embodiments, the server 102 is programmed to access the one or more of the inviter's communication accounts and download the communications into the database 220 as soon as the credentials for the one or more communication accounts are received, according a specific schedule, or in response to a relevant search, such as a search by the invitee. The download can be incremental to a previous download. The server 102 is further programmed to apply each selection criterion provided by the invitee for the alliance to the digital communications in the one or more communication accounts to obtain a set of the inviter's digital communications specific to the inviter or another individual in the invitee's alliance network according to a specific schedule or in response to a relevant search.

In some embodiments, the server 102 is configured to further identify a list of contacts from the set of the inviter's digital communications and corresponding relationship strengths. For example, when the set of the inviter's digital communications is a number of email messages, the senders or recipients of each email message other than the inviter can be identified, and the number of times each of these individuals is a sender or a receiver can be used to compute the corresponding relationship strength. The inviter's digital communications can be augmented with additional data from external data sources in determining the relationship strengths. Examples of the additional data include communication information related to public conferences, events, or social networks. The server 102 is programmed to establish person data for each of the contacts based on the set of digital communications or external data sources. For example, the employer of a contact may be derived from the email address of the contact or specific remarks of the contact in the set of digital communications. Such employment information can also be retrieved from the employer's website or other public data sources. The contact can also be assigned to one of the organizations in a similar manner. Depending on the types of information regarding relationships identified from the set of the inviter's digital communications that are to be shared with the invitee or another individual in the inviter's alliance network, the server 102 can be configured to determine additional types of information concerning the relationships. For example, for each identified contact, the server 102 can be configured to compute the number of digital communications via a specific communication mechanism or within a specific period of time; the server 102 can also be configured to compile a list of headers of these digital communications or a summary of all these digital communications. The server 102 is programmed to further repeat this process with the invitee's digital communications based on the invitee's acceptance.

In some embodiments, the server 102 is programmed to obtain or compute a strength of an alliance between two user accounts, which may depend on the number or types of digital communications offered for exploration by the two user accounts, the number of other user accounts who are common allies of two two user accounts, or the number and types of interests of the two user accounts. For example, the alliance strength may be higher when the digital communications came from a private communication account as opposed to a business communication account or were transmitted during the last month as opposed to last year.

4.2. Utilizing Alliances

In some embodiments, the server 102 is programmed to receive a query from a first user device associated with the first user for relationship information associated with a second user who is an ally of the first user. In response, the server 102 is programmed to determine the list of relationships of the second user and specific types of information regarding those relationships according to the alliance with between the first user and the second user. The identification can be performed by real-time computation or based on data already stored in the database 220. For example, when the second user has agreed to share with the first user email and relationship strength information regarding his relationships based on a selection of his calendar entries, the server 102 can be configured to access the second user's calendar entries, obtain the selection of calendar entries, identify the list of contacts from the selection, and retrieve or compute the corresponding list of relationship strengths for those contacts. Alternatively, the selection of calendar entries, the list of contacts, or the list of relationship strengths may already be in the database 220 and simply need to be retrieved. Similarly, the query may be for relationship information associated with a third user who is in the first user's alliance network. The server 102 is programmed to further return the specific types of information regarding a list of relationships of the third user visible to the first user to the first user device.

In some embodiments, the server 102 is programmed to receive a query from a first user device associated with the first user for relationship information associated with allies of the first user concerning a contact. In response, the server 102 is programmed to determine the list of relationships of the allies of the first user with the contact and specific types of information regarding those relationships according to the alliance between the first user and each of the allies. Similarly, the query may be for relationship information associated with members of the alliance network of the first user concerning the contact. The server 102 is programmed to further return the specific types of information regarding a list of relationships of the members to the first user to the first user device.

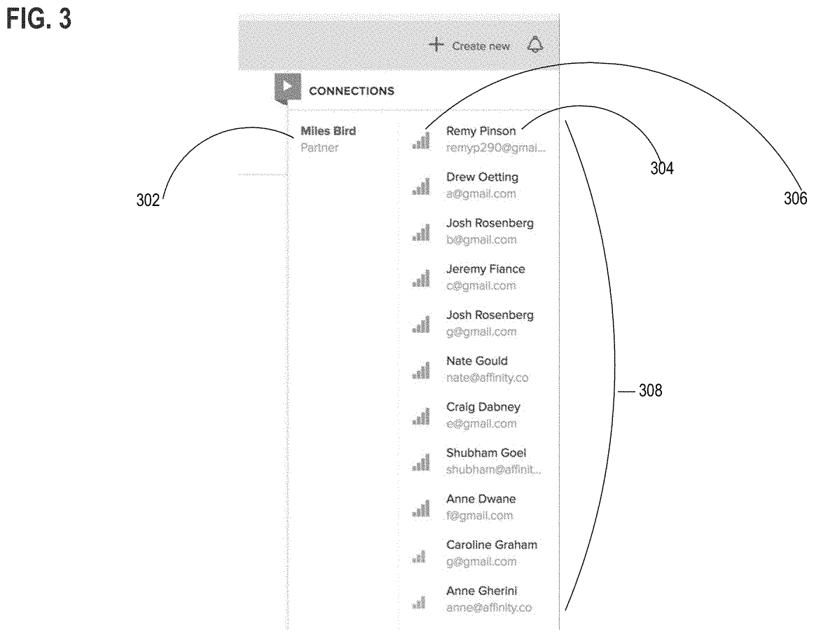

FIG. 3 illustrates an example screen of a graphical user interface that shows information regarding a list of relationships visible to a first user between each of a list of allies of the first user's account and a contact. In this example, identifying information 302 regarding the contact is displayed. A list of entries 308 corresponding to the list of relationships each including identifying information regarding an ally of the first user and the corresponding relationship strength is also displayed. Specifically, the first entry of the list includes the name and email address 304 of an ally and a relationship strength indicator 306 in the form of colored or shaded one through five bars, with more bars indicating a stronger relationship. The relationship strength indicator as shown here is for illustration only and it can have other shapes or forms. For example, it can use numerical values to indicate different relationship strengths.

The query can be expanded to be for relationship information associated with a member of the alliance network of the first user's account concerning the contact. The screen can then include additional information for each of the list of determined relationships, such as the degree or the number of alliances required from the first user to reach the contact. Each entry can also indicate information regarding at least one of these alliances. For example, when the first user's account and a second user's account are in an alliance, the second user's account and the ally with the name and email address 304 are in an alliance, a degree of two and identifying information regarding the second user can also be included in the first entry.

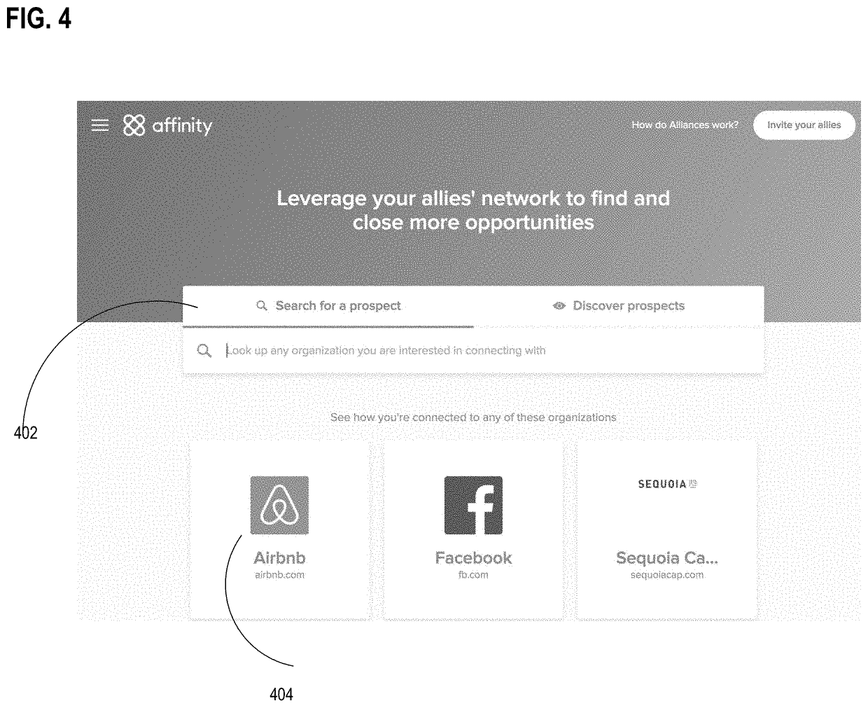

In some embodiments, the server 102 is programmed to receive a query for information regarding relationships within an organization from a first user device associated with a first user. FIG. 4 illustrates an example screen that allows querying for information regarding relationships within an organization. The screen includes a text field 402 for entering a text query, such as the name, address, or other identifying information or attributes of an organization. The screen also includes an icon 404 representing each of specific organizations, the selection of the icon leading to a query corresponding to the corresponding organization. These specific organization can be the most often searched by the first user device or by a specific group of user devices within a specific period of time. These specific organization can also be the most relevant to the first user device or the first user, such as prospective customers or employers for the first user.

In some embodiments, in response to the query, the server 102 is programmed to determine the queried organization. The text query provided by the first user device can be matched to organization data in the database 220 using a pattern matching technique known to someone skilled in the art based on specific rules. For example, an organization may have subsidiaries or subdomains. Such relations can be stored as part of the organization data or encoded in the organization matching rules. The server 102 is programmed to further identify a list of relationships involving individuals who are related to those user accounts who are in the first user's alliances (or alliance network) and who belong to the organization. Specifically, person data concerning those individuals can similarly be matched to organization data based on specific rules. For each of the list of relationships, the server 102 is programmed to also determine the types of information that are visible to the first user or first user device based on the alliance data, similar to the handling of the query for relationship information associated with a second user who is in an alliance with the first user discussed above. In addition, the server 102 is configured to perform some aggregation on the list of relationships. Such aggregation can include calculating a total number of relationships that correspond to the same individual in the queried organization, an average relationship strength over these relationships, or an aggregate of other types of data visible to the first user over these relationships. Furthermore, the server 102 is programmed to transmit to the first user device the types of information accessible to the first user device regarding the list of relationships, including the aggregation data.

In some embodiments, the server 102 can be programmed to facilitate pursuit of the list of relationships determined for the first user device or any other relationship identified by the server 102. For example, a graphical user interface can be used to enable preparation and delivery of an introductory digital communication from the first user device to a device corresponding to one of the list of relationships with a few simple user interactions. Furthermore, the server 102 can be configured to analyze the calendar events or other digital communications of the first user or of an individual corresponding to one of the list of relationships and determine schedules, communication habits, or common interests of the first user or the individual. Based on the determination, the server 102 can be configured to send suggestions to the first user device on how to establish contact with the individual, subject to privacy or other constraints specified by the individual. For example, upon determining that the first user and the individual will be attending the same conference, a recommendation to make an in-person introduction before or during this conference can be transmitted to the first user device. For further example, upon determining that the individual composes a large volume of email but schedules relatively few (such as lower than 10%) telephone, video, or in-person conferences, a recommendation to make an email introduction initially can be transmitted to the first user device.

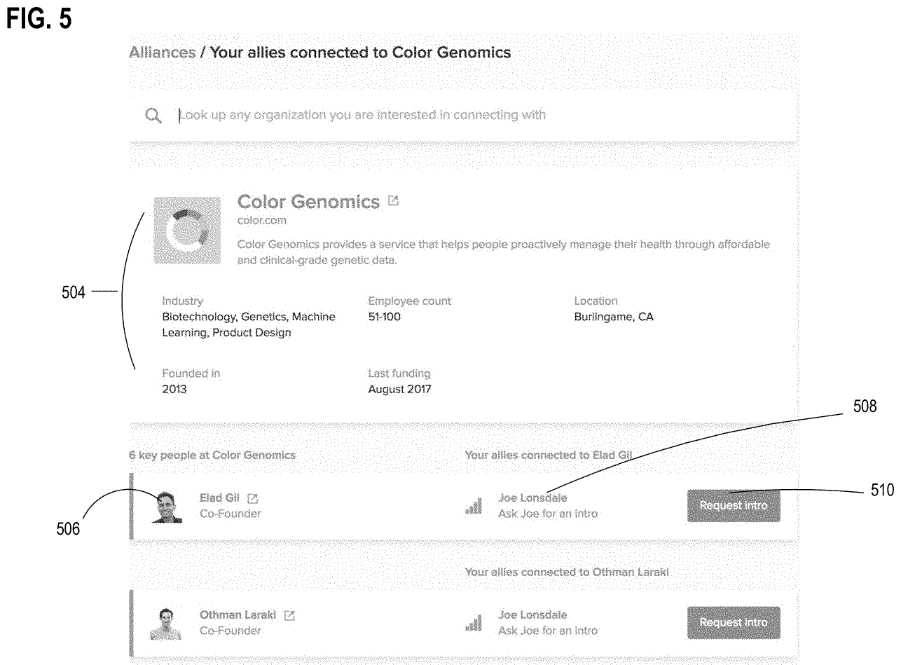

FIG. 5 illustrates an example screen that shows search results in response to a query from a first user device associated with a first user for information regarding relationships associated with an organization. The screen shows information regarding the queried organization 504, including a name, website, description, industry classification, employee count, location, year of creation, and last time of funding. Additional data regarding the organization stored in the database 220 or less data can be displayed. The screen also shows data regarding a list of relationships involving individuals in the organization who are related to those user accounts who are in the first user's alliances (or alliance network). The screen can also show data regarding one or more allies in the organization. For each of the relationships, the data can include identifying information of the corresponding individual 506, such as a name and an email address, information regarding the relationships that lead to this individual 508, such as names of one or more user accounts who are in the alliance network of the first user's account or communicate with the individual and an indication of an aggregate relationship strength over the one or more user accounts. In addition, the screen can also provide a mechanism 510 that allows the first user to contact the individual through a user associated with one of the allies of the first user's account (or a chain of people associated with the alliance network of the first user). In response to a selection or an activation of this mechanism 510, a default notification can be sent to a device of a corresponding user. Alternatively, another screen corresponding to a new digital communication addressed to that corresponding user can be presented to allow the first user to customize the notification, and the completed digital communication can be delivered to the device of that corresponding user. Alternatively, the screen can show information regarding a communication mechanism to reach the individual directly, as long as such information is visible to the first user to the relevant alliance data.

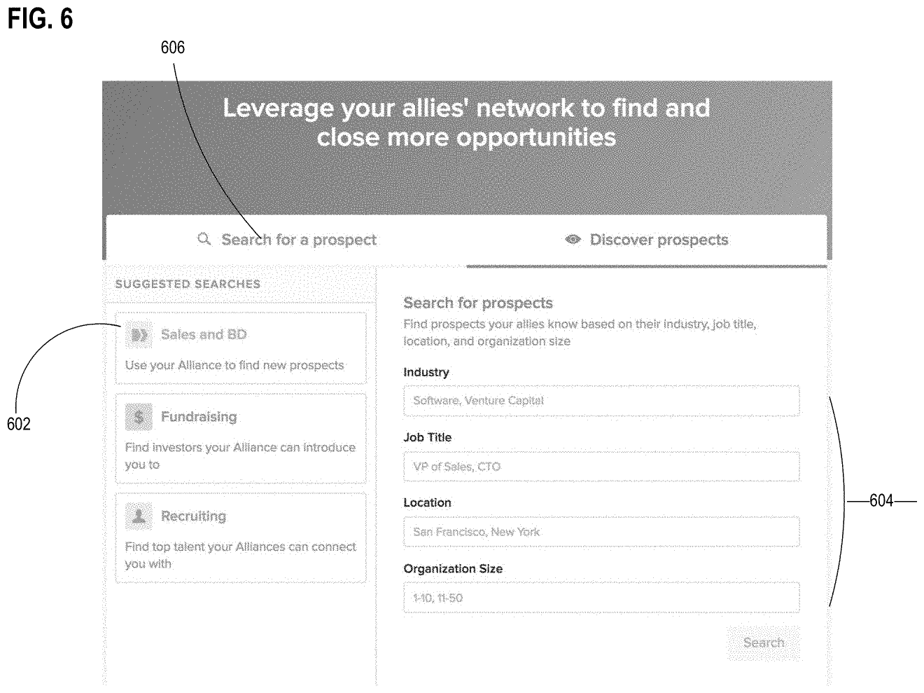

In some embodiments, the server 102 is programmed to receive a query for information regarding relationships who satisfy a certain criterion from a first user device. This query is different from a query for information regarding relationships within an organization in that this query is not limited to any organization. Therefore, the relationships found in response to this query can involve individuals who belong to any of multiple organizations or no organization at all. FIG. 6 illustrates an example screen that allows querying for information regarding relationships according to a specific criterion. The screen offers multiple ways to specify the criterion. A user can enter free-form text in the text field 606, such as the title of the position within an organization or the number of years with an organization. The screen also allows the selection of one of the buttons 602 which represent specific industries to which an organization of a prospect may belong, such as fundraising or recruiting, or which represent other specific combinations of attribute values. In addition, the screen allows the input of values into text fields 604 for specific attributes of an organization of a prospect, such as the location or size. The screen may also provide suggestions for these values based on what is already input or data from external sources. For example, in response to an input of “software” as an industry, a suggestion of “hardware” can be presented as a suggestion because these two industries are often searched together. In addition to or instead of the criterion related to an organization of a prospect, a criterion directly related to an individual, such as the age or number of alliances, can also be submitted and processed.

In some embodiments, in response to the query, the server 102 is programmed to determine the queried individuals through their organizations or directly. The query provided by the first user device can be matched to organization data or person data in the database 220 using a pattern matching technique known to someone skilled in the art based on specific rules, similar to the handling of a query for information related to relationships within an organization discussed above. The server 102 is programmed to ultimately identify a list of relationships involving individuals who are related to those user accounts who are in the first user's alliances (or alliance network) and who satisfy the certain criterion, determine the types of information that are accessible to the first user device based on the alliance data for each of the list of individuals, and perform some aggregation on the list of relationships, also similar to the handling of a query for information related to relationships within an organization discussed above.

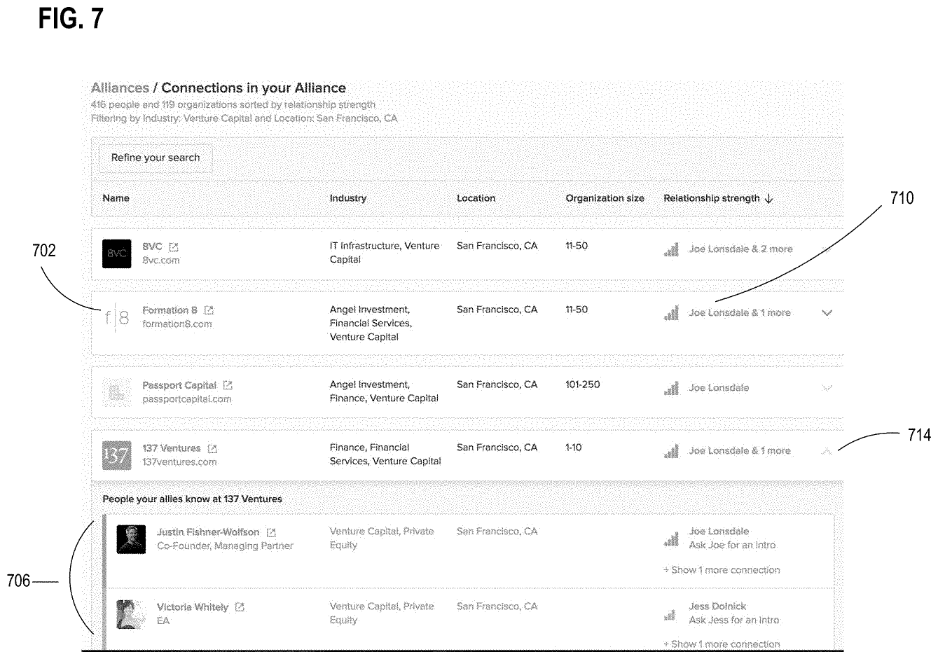

FIG. 7 illustrates an example screen that shows search results in response to a query for information regarding relationships according to a specific criterion. The screen shows information that is accessible to the first user according to the alliance data regarding each organization that satisfies the query or each organization of an individual that satisfies the query. The information can include identifying information 702, such as the name, a website, or a location, or include values of the attributes that are part of the query. For each of these organizations, the screen also shows aggregate relationship information 710, such as the number of relationships within the organization, the names of one or more user accounts who are in the first user's alliances or alliance network and who communicate with the individuals involved in these relationships, or the average relationship strength over these relationships. For example, for example, for the organization corresponding to the business entity Formation 8, Joe Lonsdale and another user are the first user's allies or are in the first user's alliance network and can be relied on to reach an individual who work for Formation 8. More detailed relationship information can also be shown. In this example, individual-level information 806 is shown as an expansion of the organization-level information, indicating information regarding the list of relationships within the organization. The user can choose to see such expanded information through a toggle 714. The screen can additionally show a list of relationships who do not belong to any organization.

In some embodiments, the server 102 is programmed to identify or suggest prospective allies or prospective contacts for a user or user device. Specifically, the server 102 can be configured to analyze the user's search history, the user's own digital communications including a corresponding communication history, the allies' search histories, or the digital communications of the user's allies that are explorable according to the alliances including a corresponding communication history. Based on the analysis, the server 102 can be configured to then identify individuals who satisfy a certain criterion predetermined by the server 102 or provided by user device. Such criteria might apply to the individual, any organization to which the individual belongs, or the relationship with the user or an ally of the user. For example, one criterion may be a contact who is a manager in a technology company who communicated with the user or an ally within the last six months. Another criterion may be an individual who is at a higher position than an existing contact (with whom the user has communicated) and with whom no other employee of the user's employer has had any digital communication. The server 102 can be programmed to further distinguish between prospective allies and prospective contacts based on specific criteria, such as the strength of the relevant relationship with the prospect, the job title of the prospect, etc. The server 102 can be programmed to determine such prospective allies or contacts according to a specific schedule or upon request by the user device and send appropriate information regarding these prospects to the user device.

In some embodiments, the server 102 is programmed to further estimate the impact of forming an alliance and communicate such estimated impact to a user device to assist the user device in deciding how to form additional alliances. The server 102 can be programmed to estimate the impact for each identified prospective ally or contact, as discussed above, or use the estimated impact to improve the identification of prospective allies or contacts. Subject to privacy or other constraints associated with each user account, the server 102 can be configured to compute certain statistics based on the relationships associated a specific user account. The statistics can be related to the relationships that can be derived from digital communications in one of the communication accounts associated with the specific user account or various attributes of these relationships. For example, the statistics can include a total count of relationships that are new to the user device, an average age of the individuals corresponding to the new relationships, or the number of different employers of those individuals. For further example, the user account might give priority to forming an alliance with the specific user account when the user account is associated with an employer in the food industry and when the statistics show that the new relationships that can be explored as a result of the alliance are associated with many employers in the food industry.

4.3. Recommending Communication Paths to Connect with New Contacts Based on Digital Alliance Data

In some embodiments, the server 102 is programmed to determine an interest hierarchy of nodes representing various interests. For example, the interest hierarchy may have a first node for sports, and under the first node have a second node for football and a third node for skiing. Thus, each node in the interest hierarchy has at least a name or label of the interest. For at least one of the nodes in the interest hierarchy, the server 102 is programmed to associate with the node one or more words, phrases, images, sound snippets, videos, or other data related to the interest represented by the node. For example, the second node can be associated with a photo of Levi's Stadium, while the third node can be associated with names of ski equipment. The server 102 can be programmed to update the interest hierarchy according to a specific schedule or in response to updates to external data sources or requests from user accounts.

4.3.1. Collecting Interest Data for Users

In some embodiments, the server 102 is programmed to collect interest data for users associated with user accounts. A user account of a user may include a user specification of interests, such as a selection of one or more nodes or pieces of the associated data in the interest hierarchy to indicate interests of the user. The server 102 is programmed to also infer a user's interests that can be mapped to nodes in the interest hierarchy from various types of data associated with the user's account, such as user data, digital alliance data, or online activity data, as further discussed below. The server 102 can be programmed to infer such interests periodically, when an interest is specified by the user, when the user account forms a new alliance or experiences an expansion of the alliance network, when the alliance network includes a new contact, or at any other user-specified times. The server 102 can be programmed to further send a request to a user device of the user for confirming or ranking any inferred interest.

In some embodiments, the server 102 is programmed to ascertain the user's interests from demographic data included in the user's profile. The industry of the user's profession or the user's employer may be correlated with or mapped to a node in the interest hierarchy. Additional demographic data, such as age, race, gender, education, residence, or marital status, can also be correlated with certain nodes in the interest hierarchy.

In some embodiments, the server 102 is programmed to determine the user's interests from the digital alliance data related to alliances and allies of the user account. As discussed previously, an alliance may correspond to an organization of a specific nature, such as a high school class, a choir, or a wine club. The specific nature may also be correlated with one of the nodes in the interest hierarchy. In addition, the server 102 can be configured to identify an interest that is shared by a certain number or a certain percentage of the group of allies or the associated users, the group of contacts, or the group of contacts associated with relationships strengths above a certain threshold as a potential interest of the user.

In some embodiments, the server 102 is programmed to determine the user's interests from the digital alliance data related to digital communications offered by the user account for exploration of relationships. The server 102 can be configured to specifically search for occurrences of the items associated with a node in the interest hierarchy in a certain set of digital communications sent from or received by the user's communication accounts. When the frequency of occurrences exceeds a certain threshold, the certain set digital communications can be correlated with the node in the interest hierarchy. A set of digital communications associated with the user account can also be mapped to a node in the interest hierarchy using any other content analysis techniques known to someone skilled in the art.

In some embodiments, the server 102 is programmed to ascertain the user's interests from online social media or other public data sources specified in the user's profile, such as websites of organizations of which the user is a member. A user's social media account generally has user data and indicates a group of online friends, which can be processed similarly as the user profile and the group of allies associated with the user account, as discussed above. The social media data can also be mined to identify interests or hobbies similarly as the digital communications associated with the user account, as discussed above. In addition, organizational websites may contain descriptions of specific activities performed by their members, which can also be processed similarly as the digital communications associated with the user account, as discussed above.

In some embodiments, the server 102 is programmed to determine the user's interests from logs of online activities of the user account. The online activities may include submitting search queries for allies, other user accounts, or new contacts to the server 102, receiving search results from the server 102, or reviewing profiles of specific users or organizations that may or may not be in the alliance network of the user account. The logs of these online activities or portions thereof can be correlated with certain nodes in the interest hierarchy. For example, when the search queries submitted by the user device of the user often include specific keywords associated with a certain node in the interest hierarchy, that certain node might represent an interest of the user. For further example, when the profiles loaded by the user device often belong to user accounts associated with a certain company, the company or the industry of the company may be mapped to a node in the interest hierarchy.

4.3.2. Collecting Interest Data for Contacts of Alliance Networks

In some embodiments, the server 102 is programmed to collect interest data for contacts of alliance networks. The interest data can be collected for contacts periodically, when the digital communications sent or received by an individual begin to be associated with one or more alliances or with a specific alliance network, when the number or frequency of such digital communications exceeds a threshold, or at any other user-specified times.

In some embodiments, the server is programmed to analyze digital communications associated with user accounts to learn about the contacts communicating with the users. The identity of the communication account used by a contact to send or receive a digital communication, which often includes a domain name managed by an organization of which the contact is a member, can be correlated with a node in the interest hierarchy. A digital communication sent to or received by the contact typically indicates the identity of the contact and often indicates additional information regarding the contact. For example, an email message may include a signature of the sender, which might indicate the sender's job position, occupation, residence or current location, social media accounts, or communication channels. The server 102 can thus be configured to parse the email message and extract the signature block, such as the portion between the last instance of the contact's name and the end of the message body. The server 102 can be further configured to then map the signature block or a portion thereof to a node in the interest hierarchy. In addition, the digital communication can be analyzed to identify additional interests of the contact just like the digital communication would be analyzed to identify the interests of the user communicating with the contact, as noted above. Specifically, the server 102 can be configured to search for occurrences of the items associated with a node in the interest hierarchy in a certain set of digital communications sent from or received by the contact's communication accounts. When the frequency of occurrences exceeds a certain threshold, the certain set of digital communications can be correlated with the node in the interest hierarchy.

In some embodiments, based on information gleaned from the digital communications sent or received by the contact, the server 102 is programmed to ascertain interests of the contact from additional data sources. For example, the signature block may include an identifier of a social media account. The personal data and social media data associated with the social media account of the contact can then be analyzed as the personal data and social media data associated with the social media account of a user would be analyzed, as discussed above.

In some embodiments, the server 102 is programmed to ascertain interests of the contact from identities of the users involved in digital communications sent or received by the contact. Specifically, the server 102 can be configured to identify an interest that is shared by a certain number or a certain percentage of the group of users who communicate with the contact as a potential interest of the contact.

4.3.3. Analyzing Interests and Communication Paths

In some embodiments, the server 102 is programmed to consider a relevance score of an interest. An interest that is more specific or is mapped to a node lower in the interest category is typically more relevant than an interest that is broader. An interest that is directly specified as such is typically more relevant than an inferred interest. The relevance of an inferred interest may depend on the nature or manner of inference. An interest of a user inferred from common interests of a group of allies may be more relevant than an interest of a contact inferred from common interests of a group of users communicating with the contact. An interest inferred from a larger number or percentage of individuals may be more relevant an interest inferred from a smaller number or percentage of individuals. An interest inferred from more recent digital communications may be more relevant from an interest inferred from older digital communications. An interest inferred from a larger number or percentage of occurrences of items associated with a node in the interest hierarchy may be more relevant than an interest inferred from a smaller number or percentage of occurrences of items associated with the node. An interest that is corroborated by data from multiple data sources may be more relevant than an interest that is backed by data from a single data source. For example, when the search queries for relationship information and the digital communications associated a user account both frequently mention “stock trading”, the user's interest in stocking trading can be very relevant. The server 102 can be programmed to assign relevant scores based on one or more of the aforementioned rules or other rules individually or in combination.

In some embodiments, the server 102 is programmed to determine whether an interest of the user matches an interest of the contact. The server 102 can be programmed to determine whether there is a match of interests periodically, as soon as an interest is determined for the user and the contact, when the number of new contacts of the alliance network of the user account exceeds a certain threshold, or at any other user-specified times. As each interest can be mapped to a node in the interest hierarchy, the server 102 can be programmed to declare a match when two interests are correlated or mapped to the same node in the interest hierarchy. In this case, the interest represented by the node can be considered as the common interest. The server 102 can also be programmed to declare a match when a first interest is mapped to a first node in the interest hierarchy and a second interest is mapped to a second node under the first node. In this case, the interest represented by the first node can be considered as the common interest. For example, the first node may represent sports in general and the second node may represent skiing. In addition, the server 102 can be programmed to declare a match when a first interest and a second are respectively mapped to a first node and a second node each within a certain distance to the closest common node above the first node and the second node. In this case, the interest represented by the closest common node can be treated as the common interest. For example, the first node may represent baseball right under and thus having a distance of one to the node representing sports in general, while the second node may represent skiing also right under and thus having a distance of one to the node representing sports in general.

In some embodiments, the server 102 can be configured to use the distance between each of the two nodes to the closest common node as a significance measure of the match of the corresponding interests. The server 102 can also be configured to determine a significance measure of the match based on the relevance scores of the individual interests. A match of two substantially relevant interests can be more significant than a match of two weakly relevant interests.

In some embodiments, upon identifying a match between the interests of the user and the contact as having a significance measure above a specific threshold, the server 102 is programmed to identify a communication path from the user to a contact. A communication path comprises a series of user accounts in the alliance network of the user account of the user from the user account to an alliance network member who has offered digital communications for exploration of relationships involving the contact such that each successive pair of user accounts are in in alliance. Because the second user is in the alliance network of the user's account, the relationship between the user and the second user is relatively strong. In addition, the smaller the number of user accounts in the communication path are, the even stronger the relationship may be. Multiple such communication paths for the user to connect with the contact may exist, each including a distinct set of members of the user's alliance network.

In some embodiments, the server is programmed to then calculate a communication score for each communication path, which would indicate how successful a new relationship between the user and the contact may be. The calculation may depend on the length of the communication path or equivalently the number of user accounts included in the communication path, the strength of each alliance between successive user accounts in the communication path, or the strength of the relationship between the contact and the user account in the communication path communicating with the contact. For example, the communication score can be higher for a more direct or shorter communication path, for a communication path involving stronger alliances, or for a communication path having a higher relationship strength between the contact and the last user account included in the communication path. In addition, the server 102 can be configured to further determine whether there is match between between an interest of a user of a first user account in the communication path and an interest of the contact or an interest of a user of a second user account in the communication path, calculate a corresponding significance measure for the match (or a minimum value if there is not match), and adjust the communication score for the communication path based on one or more of these calculated significance measures.

4.3.4. Communicating Suggestions of New Communications

In some embodiments, upon determining that the communication score of a communication path exceeds a certain threshold, the server 102 is programmed to send data related to the communication path to a user device of the user.

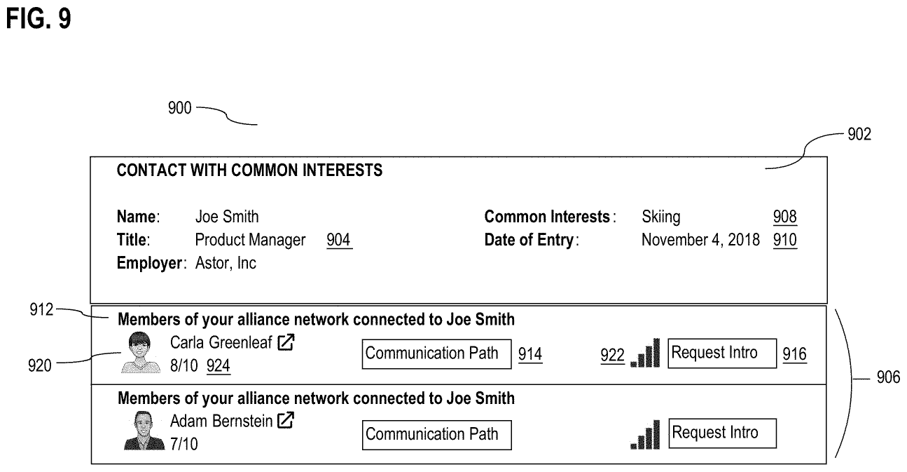

FIG. 9 illustrates an example screen of a graphical user interface that is programmed for communicating data related to communication paths to connect a user with a contact to a user device of the user. In some embodiments, the screen 900 has an upper portion 902 and a lower portion 906. The upper portion 902 can include information regarding the contact, such as the basic information 904. The upper portion 902 can also include a list of interests 908 shared with the user, such as skiing. The upper portion 902 can additionally include the date 910 when the contact connected with the alliance network of the user account or when the digital communications offered by the alliance network started including digital communications sent to or received by the contact.

In some embodiments, the lower portion 906 can include a section for each member of the alliance network who has communicated with the contact, such as the section 912. Each section may correspond to the communication path having the highest communication score out of all the communication paths including a certain member who has communicated with the contact. The sections in the lower portion 906 can be presented in order of the communication score. The section 912 can include basic information 920 regarding the corresponding member, such as a name, a photo, and a link to additional information stored in the user account of the corresponding member. The section 912 can also include the communication score 924 of the corresponding communication path, such as 8 out of 10. The section 912 can additionally include an option 914 for obtaining certain information regarding the corresponding communication path that connects the user and the contact. The certain information, which may be displayed on a different screen, may contain the length of the communication path or the name of each alliance network member included in the communication path, for example. In addition, the section 912 can also include the strength 922 of the relationship between the corresponding member and the contact, from which the communication score may be based, as noted above. Furthermore, the section 912 can include an option 916 for requesting an introduction of the user by the corresponding member to the contact subject to the privacy settings or constraints of the corresponding member. Such a privacy constraint may indicate when or how the corresponding member may want to accept such introduction request. In response to a selection of the option 916, the server 102 can be programmed to send a request to a device of the corresponding member.

In some embodiments, the server 102 is programmed to prepare and transmit additional data related to suggested communications between the user and the contact to the user device of the user. Such additional data can also be displayed in the screen illustrated in FIG. 9 or another screen of the GUI, for example. The additional data can describe the data used to determine the common interests. For example, the additional data can indicate that both of the user's social media and the digital communications of the contact discuss alpine skiing in the recent Winter Olympics. The additional data can also include the specific portions of the social media or the digital communications that are correlated to the node representing skiing in the interest hierarchy. The server 102 can be configured to further identify opportunities for the user and the contact to connect, and the additional data can describe these opportunities. The opportunities may be identified similarly as the common interests were identified except that the opportunities are focused on activities that can be performed together in the future or that facilitate an introduction of the user to the contact. For example, the opportunities can be that both the user and the contact are scheduled to attend the same event, belong to the same organization that will host a certain event, or have children who will attend the same event. The server 102 can be programmed to transmit the additional data to the user device of the user together with the data related to the communication paths, close to when the relevant activities are to take place, or at other user-specified times.

In some embodiments, the server 102 is programmed to send data related to a request for introducing the user to a contact of the alliance network member included in an identified communication path in response to a request from the user device of the user for an introduction, as noted above. Alternatively, the server 102 can be programmed to automatically send such data to the user device of the alliance network member upon identifying the communication path for the user subject to the privacy settings or other constraints of the alliance network member, as noted above.

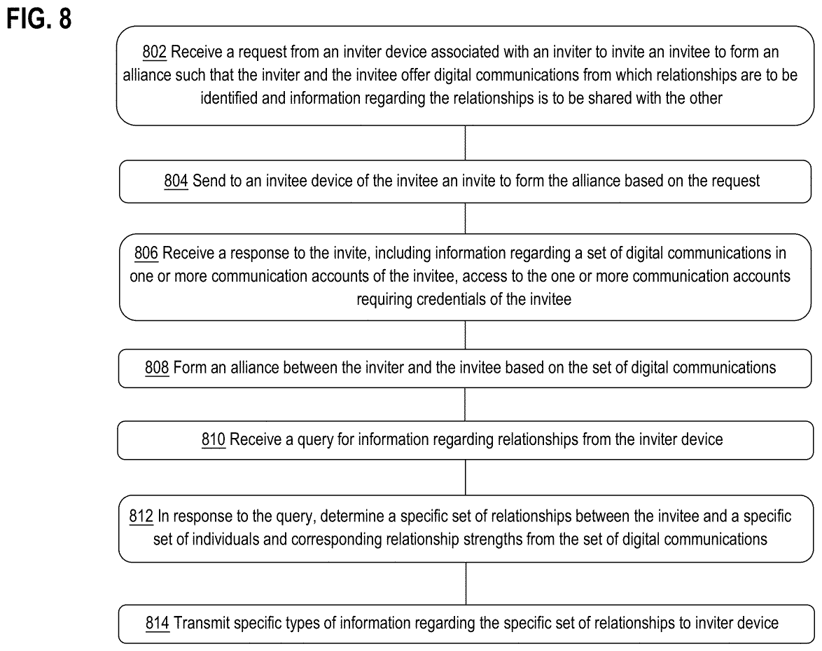

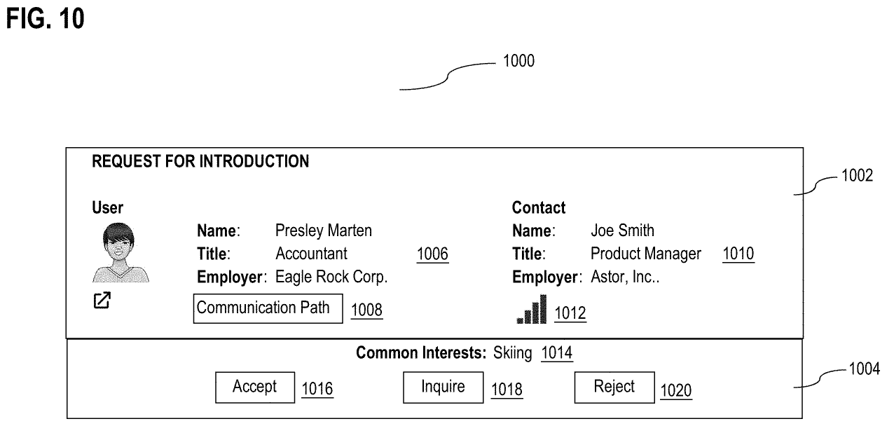

FIG. 10 illustrates an example screen of a graphical user interface that is programmed for communicating data related to a request for introducing a user to a contact to a user device of a member of an alliance network of the user's user account. In some embodiments, the screen 1000 has an upper portion 1002 and a lower portion 1004. The upper portion 1002 can include information regarding the user, such as the basic information 1006. The basic information can include a photo, the name, items related to the profession, and a link to additional information stored in the user account of the user. The upper portion 1002 can further include an option 1008 for obtaining certain information regarding the communication path that connects the user to the alliance network member and ultimately to the contact, similar to the option 914 in FIG. 8. In addition, the upper portion 1002 can include information regarding the contact, such as the basic information 1010. The upper portion 1002 can additionally indicate the strength 1012 of the relationship between the alliance network member and the contact.

In some embodiments, the lower portion 1004 can include a list of common interests 1014 of the user and the contact. In addition, the lower portion 1004 can include one or more options for responding to the request. One option 1016 is to accept the request, indicating an agreement to introduce the user to the contact. Another option 1018 is to send an inquiry to a device of the user for more information. Yet another option 1020 is to reject the request, indicating a refusal to introduce the user to the contact.

In some embodiments, the server 102 is programmed to prepare and transmit additional data related to suggested communications between the alliance network member and the contact to the device of the alliance network member. Such additional data can also be displayed in the screen illustrated in FIG. 10 or another screen of the GUI, for example. The additional data can describe the digital communications between the alliance network member and the contact. The server 102 can be configured to further identify opportunities for the user, the contact, and the alliance network member to connect, and the additional data can describe these opportunities. The opportunities may be identified similarly as the opportunities for the user and the contact to connect, as noted above. The server 102 can be programmed to transmit the additional data to the device of the alliance network member together with the data related to the request for introduction, close to when the relevant activities are to take place, or at other user-specified times.

In some embodiments, the server 102 is programmed to update the list of communication paths for the user to connect with the contact and the corresponding communication scores on a regular basis. A new communication path may be formed when another alliance network member or the associated user starts sharing digital communications sent to or received by the contact or when a new alliance is newly formed which adds a particular user account that communicates with the contact to the alliance network of the user account. The communication score of an existing communication path may change when the strength of the relationship between the contact and the alliance network member communicating with the contact changes. In response to newly identifying a communication path having a communication score above the certain threshold, the server 102 can be programmed to send data related to the communication path to the user device of the user or data related to a request for introduction to a device of the last user account in the communication path, as noted above.

In some embodiments, some or all of the approaches discussed in this Section 4.3 may be applied to recommend new relationships between a first user account and a second user account that is not an ally or that is not an alliance network member to the first user account. These approaches may also be applied to recommend new relationships for a first user account by relying on a third user account for introduction, where the third that is not an alliance network member to the first user account but is related to the first user account through one or more alliances.

5. Example Processes

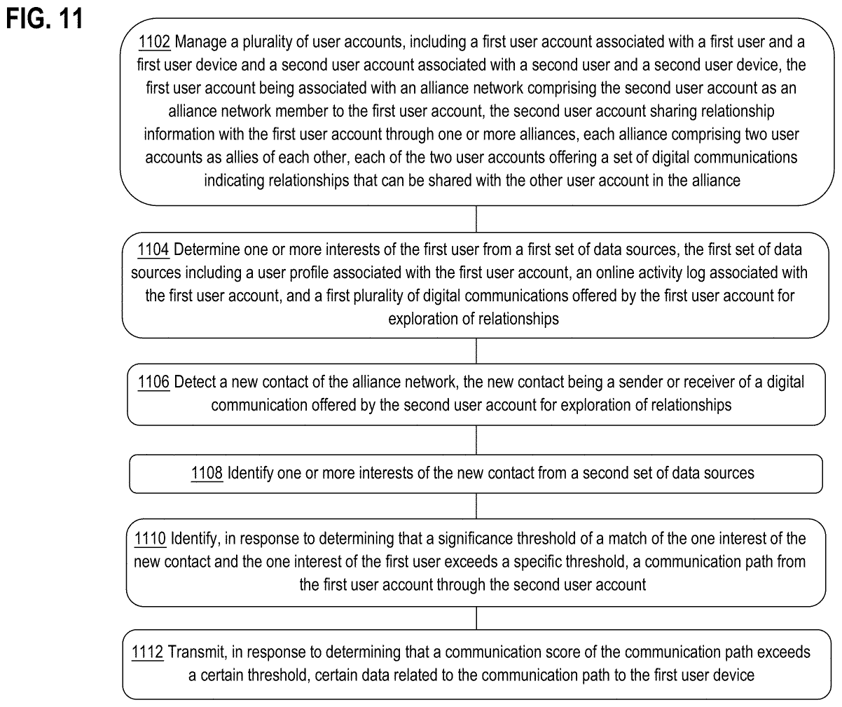

FIG. 8 illustrates an example process performed by the server of managing alliances and associated relationship data alliances. FIG. 11 illustrates an example process that the communication management server can execute for recommending communication paths to connect with a new contact. FIG. 8 and FIG. 11 are each shown in simplified, schematic format for purposes of illustrating a clear example and other embodiments may include more, fewer, or different elements connected in various manners. FIG. 8 and FIG. 11 are each intended to disclose an algorithm, plan or outline that can be used to implement one or more computer programs or other software elements which when executed cause performing the functional improvements and technical advances that are described herein. Furthermore, the flow diagrams herein are described at the same level of detail that persons of ordinary skill in the art ordinarily use to communicate with one another about algorithms, plans, or specifications forming a basis of software programs that they plan to code or implement using their accumulated skill and knowledge.

In some embodiments, in step 802, the server 102 is programmed or configured to receive a request from an inviter device associated with an inviter to invite an invitee to form an alliance such that the inviter and the invitee offer digital communications from which relationships are to be identified and information regarding the relationships is to be shared with the other. To form an alliance, the initial request or subsequent communications with the server 102 would include credentials for one or more communication accounts of the inviter. The initial request or subsequent communications would also include a selection criterion to be applied to the digital communications in the one or more communication accounts to form a set of digital communications unless all the digital communications in the one or more communication accounts are to be associated with the alliance by default. Furthermore, the initial request or subsequent communications would include a specification of types of information regarding relationships identified from the inviter's set of digital communications unless the name of each contact and a corresponding relationship strength are to be used by default.

In step 804, the server 102 is programmed or configured to send to an invitee device of the invitee an invitation to form the alliance based on the request. Information as to how to reach the invitee device would be included in the request unless the invitee device is already in communication with the server 102. The invitation would include at least a portion of the data in the request, and more data can be sent to the invitee device upon request. The invitation can be sent directly to the invitee device or through a communication account of the invitee.

In step 806, the server 102 is programmed or configured to receive a response to the invite. A response accepting the invitation would typically include information regarding a set of digital communications in one or more communication accounts of the invitee, access to the one or more communication accounts requiring credentials of the invitee. The response or subsequent communications with the server 102 can include the other data required for forming the alliance, similar to those sent to the server 102 by the inviter device.

In step 808, the server 102 is programmed or configured to form an alliance between the inviter and the invitee based on the set of digital communications of the inviter and the invitee. The data required for forming the alliance can be saved in a database. The set of digital communications of the inviter and the invitee can be retrieved, filtered, or mined as soon as the credentials for accessing the communication accounts of the inviter or the invitee are received, according to a specific schedule, or in response to relevant queries. In addition, the server 102 can be configured to ultimately form separate alliances between the inviter device and other devices, and similarly between the invitee device and additional devices.

In step 810, the server 102 is programmed or configured to receive a query for information regarding relationships from the inviter device. The query could also come from the invitee device, and the query processing would be the same except that the roles of the inviter and the invitee are switched. The query could be limited to relationships within certain organizations, which may correspond to prospective customers or employers of the inviter, for example.

In step 812, in response to the query, the server 102 is programmed or configured to determine a specific set of relationships between the invitee and a specific set of individuals (contacts) and corresponding relationship strengths from the set of digital communications of the invitee associated with the alliance. For example, when the invitee chats on a daily basis with a certain individual based on the set of digital communications of the invitee, the corresponding relationship strength might be relatively high. The server 102 can also be configured to determine values of various attributes of each of the specific set of contacts, such as gender, employer, title, location, organization, etc. from the digital communications with the contact, the local database, or external data sources. For example, the title of the contact might be extracted from the signature block of a digital communication of the contact. When the inviter device has formed separate alliances with other devices, the server is configured to also repeat the process with the sets of digital communications of the user accounts associated with those separate alliances. The server 102 can be programmed to further aggregate data regarding the specific set of relationships by industry, organization, or distinct individual.

In step 814, the server 102 is programmed or configured to transmit specific types of information regarding the specific set of relationships to inviter device. The specific types of information by default could be the name of a contact in the relationship and the corresponding relationship, or include additional data, such as headers or summaries of the digital communications, according to the invitee's specification.

In some embodiments, in step 1102, the server 102 is programmed or configured to manage a plurality of user accounts, including a first user account associated with a first user and a first user device and a second user account associated with a second user and a second user device. The first user account is associated with an alliance network comprising the second user account as an alliance network member to the first user account in that the second user account shares relationship information with the first user account through one or more alliances. Each alliance comprises two user accounts as allies of each other, each of the two user accounts offering a set of digital communications indicating relationships that can be shared with the other user account in the alliance.

In some embodiments, the server 102 is programmed or configured to create an interest hierarchy having a plurality of nodes, each node representing an interest. In step 1104, the server 102 is programmed or configured to determine one or more interests of the first user with respect to the interest hierarchy from a first set of data sources. The first set of data sources includes a user profile associated with the first user account, an online activity log associated with the first user account, and a first plurality of digital communications offered by the first user account for exploration of relationships. The online activity log can indicate one or more search queries from by the first user account and corresponding search results. The first set of data sources can further include first data related the list of allies or alliance network members to the first user account or second data of one or more social media accounts of the first user specified in the user profile of the first user.

In some embodiments, in step 1106, the server 102 is programmed or configured to detect a new contact of the alliance network, the new contact being a sender or receiver of a digital communication offered by the second user account for exploration of relationships. The detection can be performed periodically, when a digital communication sent to or received by the new contact is initially offered by one of the plurality of user accounts for exploration of relationships, or in response to a specific request by the first user.

In some embodiments, in step 1108, the server 102 is programmed or configured to identify one or more interests of the new contact with respect to the interest hierarchy from a second set of data sources. The second set of data sources can include the set of digital communications offered by the plurality of user accounts that involve the new contact.

In some embodiments, the server is programmed or configured to determine a significance measure of a match of the one interest of the new contact and the one interest of the first user based on a first position in the interest hierarchy of a first node to which the one interest of the new contact is mapped and a second position in the interest hierarchy of a second node the one interest of the first user is mapped. In step 1110, the server 102 is programmed or configured to identify, in response to determining that the significance measure of the match exceeds a specific threshold, a communication path from the first user account through the second user account. The communication path comprises a series of user accounts in the alliance network of the first user account where successive user accounts are in an alliance; multiple communication paths might exist from the first user account through to the second user account.

In some embodiments, the server 102 is programmed or configured to determine the communication score based on a length of a communication path or a strength of a relationship between the second user and the new contact. In step 1112, the server is programmed or configured to transmit, in response to determining that a communication score of the communication path exceeds a certain threshold, certain data related to the communication path to the first user device. The certain data can include information regarding the second account, information regarding the new contact, information regarding the one interest of the first user, information regarding the one interest of the new contact, and the communication score.

In some embodiments, the server 102 is programmed or configured to also transmit, in response to determining that a communication score of the communication path exceeds the certain threshold, specific data related to a request for introducing the first user to the new contact to the second user device. The specific data can include information regarding the first user account, information regarding the new contact, and a strength of relationship between the second user and the new contact. The server 102 is further programmed or configured to, in response to determining that no communication score of any communication path from the first user account through the second user account exceeds the certain threshold, recompute the communication score of the communication path or identify a new communication path and computing a communication score of the new communication path.

6. Hardware Implementation

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

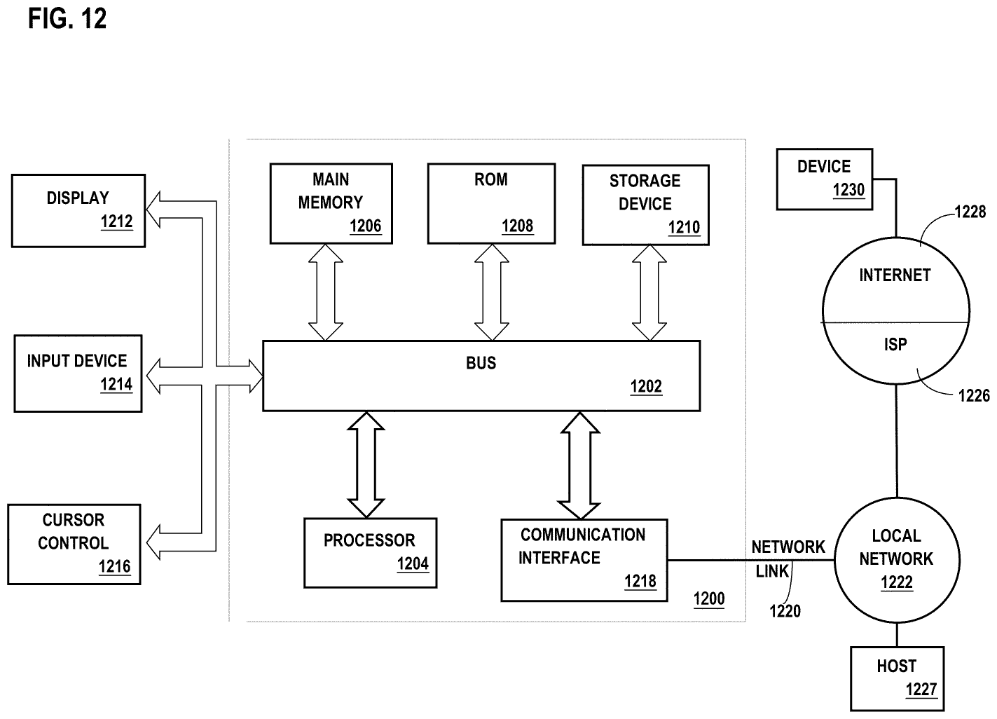

For example, FIG. 12 is a block diagram that illustrates a computer system 1200 upon which an embodiment of the invention may be implemented. Computer system 1200 includes a bus 1202 or other communication mechanism for communicating information, and a hardware processor 1204 coupled with bus 1202 for processing information. Hardware processor 1204 may be, for example, a general purpose microprocessor.

Computer system 1200 also includes a main memory 1206, such as a random access memory (RAM) or other dynamic storage device, coupled to bus 1202 for storing information and instructions to be executed by processor 1204. Main memory 1206 also may be used for storing temporary variables or other intermediate information during execution of instructions to be executed by processor 1204. Such instructions, when stored in non-transitory storage media accessible to processor 1204, render computer system ˜00 into a special-purpose machine that is customized to perform the operations specified in the instructions.

Computer system 1200 further includes a read only memory (ROM) 1208 or other static storage device coupled to bus 1202 for storing static information and instructions for processor 1204. A storage device 1210, such as a magnetic disk, optical disk, or solid-state drive is provided and coupled to bus 1202 for storing information and instructions.

Computer system 1200 may be coupled via bus 1202 to a display 1212, such as a cathode ray tube (CRT), for displaying information to a computer user. An input device 1214, including alphanumeric and other keys, is coupled to bus 1202 for communicating information and command selections to processor 1204. Another type of user input device is cursor control 1216, such as a mouse, a trackball, or cursor direction keys for communicating direction information and command selections to processor 1204 and for controlling cursor movement on display 1212. This input device typically has two degrees of freedom in two axes, a first axis (e.g., x) and a second axis (e.g., y), that allows the device to specify positions in a plane.

Computer system 1200 may implement the techniques described herein using customized hard-wired logic, one or more ASICs or FPGAs, firmware and/or program logic which in combination with the computer system causes or programs computer system 1200 to be a special-purpose machine. According to one embodiment, the techniques herein are performed by computer system 1200 in response to processor 1204 executing one or more sequences of one or more instructions contained in main memory 1206. Such instructions may be read into main memory 1206 from another storage medium, such as storage device 1210. Execution of the sequences of instructions contained in main memory 1206 causes processor 1204 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 1210. Volatile media includes dynamic memory, such as main memory 1206. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 1202. Transmission media can also take the form of acoustic or light waves, such as those generated during radio-wave and infra-red data communications.

Various forms of media may be involved in carrying one or more sequences of one or more instructions to processor 1204 for execution. For example, the instructions may initially be carried on a magnetic disk or solid-state drive of a remote computer. The remote computer can load the instructions into its dynamic memory and send the instructions over a telephone line using a modem. A modem local to computer system 1200 can receive the data on the telephone line and use an infra-red transmitter to convert the data to an infra-red signal. An infra-red detector can receive the data carried in the infra-red signal and appropriate circuitry can place the data on bus 1202. Bus 1202 carries the data to main memory 1206, from which processor 1204 retrieves and executes the instructions. The instructions received by main memory 1206 may optionally be stored on storage device 1210 either before or after execution by processor 1204.

Computer system 1200 also includes a communication interface 1218 coupled to bus 1202. Communication interface 1218 provides a two-way data communication coupling to a network link 1220 that is connected to a local network 1222. For example, communication interface 1218 may be an integrated services digital network (ISDN) card, cable modem, satellite modem, or a modem to provide a data communication connection to a corresponding type of telephone line. As another example, communication interface 1218 may be a local area network (LAN) card to provide a data communication connection to a compatible LAN. Wireless links may also be implemented. In any such implementation, communication interface 1218 sends and receives electrical, electromagnetic or optical signals that carry digital data streams representing various types of information.

Network link 1220 typically provides data communication through one or more networks to other data devices. For example, network link 1220 may provide a connection through local network 1222 to a host computer 1224 or to data equipment operated by an Internet Service Provider (ISP) 1226. ISP 1226 in turn provides data communication services through the world wide packet data communication network now commonly referred to as the “Internet” 1228. Local network 1222 and Internet 1228 both use electrical, electromagnetic or optical signals that carry digital data streams. The signals through the various networks and the signals on network link 1220 and through communication interface 1218, which carry the digital data to and from computer system 1200, are example forms of transmission media.

Computer system 1200 can send messages and receive data, including program code, through the network(s), network link 1220 and communication interface 1218. In the Internet example, a server 1230 might transmit a requested code for an application program through Internet 1228, ISP 1226, local network 1222 and communication interface 918.

The received code may be executed by processor 1204 as it is received, and/or stored in storage device 1210, or other non-volatile storage for later execution.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A computer-implemented method of recommending communication paths to connect with new contacts, comprising:
managing, by a processor, a plurality of user accounts, including a first user account associated with a first user and a first user device and a second user account associated with a second user and a second user device,
the first user account being associated with an alliance network comprising the second user account as an alliance network member to the first user account, the second user account sharing relationship information with the first user account through one or more alliances, each alliance comprising two user accounts as allies of each other, each of the two user accounts offering a set of digital communications indicating relationships that can be shared with the other user account in the alliance;
determining, by the processor, one or more interests of the first user from a first set of data sources,
the first set of data sources including a user profile associated with the first user account, an online activity log associated with the first user account, and a first plurality of digital communications offered by the first user account for exploration of relationships;
detecting a new contact of the alliance network,
the new contact being a sender or receiver of a digital communication offered by the second user account for exploration of relationships;
identifying one or more interests of the new contact from a second set of data sources;
in response to determining that a significance measure of a match of the one interest of the new contact and the one interest of the first user exceeds a specific threshold, identifying a communication path from the first user account through the second user account;
in response to determining that a communication score of the communication path exceeds a certain threshold, transmitting certain data related to the communication path to the first user device.

2. The computer-implemented method of claim 1, further comprising
creating an interest hierarchy having a plurality of nodes, each node representing an interest,
each of the one or more interests of the first user or the new contact is mapped to a node in the interest hierarchy.

3. The computer-implemented method of claim 2, further comprising determining the significance measure of the match of the one interest of the new contact and the one interest of the first user based on a first position in the interest hierarchy of a first node to which the one interest of the new contact is mapped and a second position in the interest hierarchy of a second node to which the one interest of the first user is mapped.

4. The computer-implemented method of claim 1, the online activity log indicating one or more search queries from by the first user account and corresponding search results.

5. The computer-implemented method of claim 1, the first set of data sources further including first data related the list of allies or alliance network members to the first user account or second data of one or more social media accounts of the first user specified in the user profile of the first user.

6. The computer-implemented method of claim 1, the detecting being performed periodically, when a digital communication sent to or received by the new contact is initially offered by one of the plurality of user accounts for exploration of relationships, or in response to a specific request by the first user.

7. The computer-implemented method of claim 1, the second set of data sources including the set of digital communications offered by the plurality of user accounts that involve the new contact.

8. The computer-implemented method of claim 1, further comprising determining the communication score based on a length of a communication path or a strength of a relationship between the second user and the new contact.

9. The computer-implemented method of claim 1, the certain data including information regarding the second account, information regarding the new contact, information regarding the one interest of the first user, information regarding the one interest of the new contact, and the communication score.

10. The computer-implemented method of claim 1, further comprising, in response to determining that the communication score of the communication path exceeds the certain threshold, transmitting specific data related to a request for introducing the first user to the new contact to the second user device.

11. The computer-implemented method of claim 10, the specific data including information regarding the first account, information regarding the new contact, and a strength of relationship between the second user and the new contact.

12. The computer-implemented method of claim 1, further comprising in response to determining that no communication score of any communication path from the first user account through the second user exceeds the certain threshold, recomputing the communication score of the communication path or identifying a new communication path and computing a communication score of the new communication path.

13. The computer-implemented method of claim 1, further comprising:
receiving a request for introduction by the second user of the first user to the new contact from the first user device;
transmitting the request for introduction to the second user device.

14. One or more non-transitory storage media storing instructions which, when executed by one or more computing devices, cause performance of a method of recommending communication paths to connect with new contacts, the method comprising:
managing a plurality of user accounts, including a first user account associated with a first user and a first user device and a second user account associated with a second user and a second user device,
the first user account being associated with an alliance network comprising the second user account as an alliance network member to the first user account, the second user account sharing relationship information with the first user account through one or more alliances, each alliance comprising two user accounts as allies of each other, each of the two user accounts offering a set of digital communications indicating relationships that can be shared with the other user account in the alliance;
determining one or more interests of the first user from a first set of data sources,
the first set of data sources including a user profile associated with the first user account, an online activity log associated with the first user account, and a first plurality of digital communications offered by the first user account for exploration of relationships;
detecting a new contact of the alliance network,
the new contact being a sender or receiver of a digital communication offered by the second user account for exploration of relationships;
identifying one or more interests of the new contact from a second set of data sources;
in response to determining that a significance measure of a match of the one interest of the new contact and the one interest of the first user exceeds a specific threshold, identifying a communication path from the first user account through the second user account;
in response to determining that a communication score of the communication path exceeds a certain threshold, transmitting certain data related to the communication path to the first user device.

15. The one or more non-transitory storage media of claim 14, the online activity log indicating one or more search queries from by the first user account and corresponding search results.

16. The one or more non-transitory storage media of claim 14, the first set of data sources further including first data related the list of allies or alliance network members or second data of one or more social media accounts of the first user specified in the user profile of the first user.

17. The one or more non-transitory storage media of claim 14, the detecting being performed periodically, when a digital communication sent to or received by the new contact is initially offered by one of the plurality of user accounts for exploration of relationships for exploration of relationships, or in response to a specific request by the first user.

18. The one or more non-transitory storage media of claim 14, the second set of data sources including the set of digital communications offered by the plurality of user accounts that involve the new contact.

19. The one or more non-transitory storage media of claim 14, the method further comprising determining the communication score based on a length of a communication path or a strength of a relationship between the second user and the new contact.

20. The one or more non-transitory storage media of claim 14, the certain data including information regarding the second account, information regarding the new contact, information regarding the one interest of the first user, information regarding the one interest of the new contact, and the communication score.

21. The one or more non-transitory storage media of claim 14, the method further comprising, in response to determining that the communication score of the communication path exceeds the certain threshold, transmitting specific data related to a request for introducing the first user to the new contact to the second user device.

22. The one or more non-transitory storage media of claim 21, the specific data including information regarding the first account, information regarding the new contact, and a strength of relationship between the second user and the new contact.

23. The one or more non-transitory storage media of claim 14, the method further comprising in response to determining that no communication score of any communication path from the first user account through the second user account exceeds the certain threshold, recomputing the communication score of the communication path or identifying a new communication path and computing a communication score of the new communication path.
